(19) United States
(12) Patent Application Publication
(10) Pub. No.: US 2013/0164412 A1
(43) Pub. Date: Jun. 27, 2013

(54) MODIFIED OR INFUSED CINNAMON STICKS FOR BEVERAGE AND FOOD USE

(71) Applicant: Udi Amrani, Tel Aviv (IL)

(72) Inventor: Udi Amrani, Tel Aviv (IL)

(21) Appl. No.: 13/722,379

(22) Filed: Dec. 20, 2012

Related U.S. Application Data
(60) Provisional application No. 61/579,650, filed on Dec. 23, 2011.

(51) Int. Cl. A23L 1/223

(52) U.S. Cl. CPC A23L 1/223
USPC 426/72; 426/442; 426/311; 426/321; 426/638; 426/89

(57) ABSTRACT

Flavor infused cinnamon sticks and a method for making the same. Natural cinnamon sticks are infused with various flavors, flavor pre-cursors, or other agents such as vitamins, sweeteners, or food colorants. The cinnamon sticks provide a natural matrix for carrying the various flavors or other agents, as well as providing a convenient handheld stirrer when used to add flavor to a beverage. Although ground cinnamon produces an intense amount of cinnamon flavor that would dominate over other infused flavors, the cinnamon flavor in intact cinnamon sticks leaches out only slowly, and thus the cinnamon flavor can harmoniously co-exist with the various infused flavors. Various methods of producing the infused cinnamon sticks are also taught.

### CROSS REFERENCE TO RELATED APPLICATIONS

This application claims the priority benefit of U.S. provisional application 61/579,650 entitled “FLAVOR-INFUSED CINNAMON STICK AND METHOD OF MAKING THE SAME”, inventor Udi Amrani, filed Dec. 23, 2011, the contents of which are incorporated herein by reference.

### BACKGROUND OF THE INVENTION

1. Field of the Invention

This invention is in the field of food and spice technology, particularly as it relates to beverages.

2. Description of the Related Art

Cinnamon stick prior art: Cinnamon sticks are often used to add flavor either during the cooking or preparation phase of food & beverages. Cinnamon has a distinctive pungent and slightly sweet aroma and is a popular flavor addition to many sweet and savory foods and to hot drinks like infusions. Cinnamon has been used as a spice for many thousands of years and it is used in stick form or ground is a traditional one. Cinnamon is native to many countries which include: Bangladesh, Sri Lanka, Malabar Coast of India and Burma and others. Portuguese traders landed in Ceylon (Sri Lanka) at the beginning of the sixteenth century and restructured the traditional production and management of cinnamon by the Sinhalese, who later held the monopoly for cinnamon in Ceylon. From there the Cinnamon trade has developed and is now one of the most popular spices for flavoring many foods and beverages. Cinnamon is an evergreen tree that is kept as a bush to a height of 2-3 m. The soil conditions are very important, as a waterlogged soil will produce a bitter cinnamon bark. The plant is harvested during the wet season which facilitates the peeling of the bark. Harvesting involves the removal of the stems which are selected based on their size and quality (infestation etc). The cut curled pieces of peeled bark (quills) are placed one inside another to make lm long ‘compound quills’. The ‘compound quills’ are placed on coir rope racks and dried in the shade to prevent warping. Final moisture content is usually around 12%.

The flavor of cinnamon is due to a range of aromatic essential oils (0.5% to 1% of its composition). Its pungent taste and scent is from a variety of polyphenolics like cinnamaldehyde, ethyl cinnamate and eugenol. It is one of the few spices that can be used in sweet and savory foods.

Cinnamon sticks are a safe alternative to ground cinnamon as a food additive. Ground cinnamon often contains high levels of coumarin which can be damaging to the liver and kidney. Due to their lower oil content, cinnamon sticks provides the same health benefits of ground cinnamon without the concerns of toxicity. In terms of food and beverage flavoring, cinnamon sticks have long been used in meats, rice, broths, desserts and beverages.

Cinnamon has a pungent, aromatic flavor, which can mask the unpleasant notes and complement other flavors. It can help with mouth feel and can be used to reduce levels of fats in manufactured food. Studies have shown cinnamon sticks to have antimicrobial properties effectively inhibiting growth of bacteria. The anti-inflammatory and antioxidant properties of cinnamon's polyphenols make cinnamon sticks a good choice as a natural food preservative. Cinnamon sticks have also been implicated in the control of blood sugar levels and it has been suggested that it could help in the treatment of diabetes and high cholesterol with no ill effects. In animal studies, cinnamon has also demonstrated promising results with results suggesting cinnamon sticks could be useful in combating Alzheimer's, melanoma, and HIV, amongst other diseases. As well as a low calorie natural flavor, cinnamon sticks have significant levels of magnesium, iron, and calcium.

### Beverage Art

Flavor has been incorporated onto or with tea leaves for many years now. Flavor houses can supply extracts and flavors specifically for this end-use. To apply an extract to the tea, the flavoring agent is poured or sprayed over the dry leaf and then the leaves are blended (mixed) to ensure an even distribution. Companies do this in large rotating drums filled with hundreds of kilograms of tea. Most teas can be flavored in less than 30 minutes, though some flavors do require significantly longer.

Scented teas, like Jasmine or Lapsang Souchong, derive their flavor and aroma simply from proximity to strong flavors. While some jasmine teas may be artificially flavored, “real” jasmine teas are scented with Jasmine blossoms which are then removed (jasmine blossoms have a much shorter shelf life than tea). Lapsang Souchong is scented by being exposed to the smoke of burning pine root.

### Prior Art on Infusion Methods

Cinnamon's use in chewing gum is well known (Cherukuri et al., U.S. Pat. No. 4,722,845). Other industries, such as the tobacco industry has also experimented with the incorporation of flavors. For example, Yang et. al., U.S. Pat. No. 7,856,988 describes a process of manufacturing a reconstituted tobacco material by mixing tobacco particles with a menthol liquid flavorant. Pergola et. al., U.S. Pat. No. 5,518,743 describes impregnating paper with flavoring agents.

### BRIEF SUMMARY OF THE INVENTION

Perhaps due to the fact that cinnamon sticks have such a pungent natural aroma that, when ground up, the cinnamon flavor itself tends to dominate any other flavorant, no prior art pertaining to the concept of trying to further flavor cinnamon sticks is evident.

The present invention pertains to cinnamon sticks which have been modified by using additional flavors or other additives prior to use.

The invention is based, in part, on the insight that if the instinctive prejudice against trying to further flavor a cinnamon stick is useless is overcome, certain benefits might result. Although cinnamon when ground up does indeed generate such an intense flavor as to overwhelm smaller amounts of flavorants, cinnamon sticks do not have this issue.

The invention is also based, in part, on the observation that when cinnamon sticks immersed in a beverage, such as briefly used to stir a hot beverage or steep in a hot beverage for a few minutes, the cinnamon stick remains quite intact. Only trace amounts of cinnamon are eluded from the cinnamon stick into the beverage, resulting in a mild or subtle cinnamon taste, rather than an overwhelming cinnamon taste.

The invention is also based, in part, on the insight that in situations like this, where the cinnamon stick is being used as a convenient delivery system to provide trace amounts of cinnamon flavor to a food or beverage, then the cinnamon stick can also be used at the same time as a delivery mechanism to other useful agents to the food or beverage as well. Often these other agents will be complementary flavors, vitamins, food colorant, and the like.

The invention is also based, in part, on the insight that in a preferred embodiment, if a cinnamon stick is used as a matrix to carry other useful agents as well, then the methods to infuse these agents into the cinnamon stick should ideally preserve the natural stiffness of the cinnamon stick, as well as operate on cinnamon stick lengths of approximately 2-5 inches, such as approximately 3 inches. This is because given typical beverage containers such as cups, this type of length allows most of the cinnamon stick to be immersed in the beverage container, while allowing at least a stub of the cinnamon stick to protrude above the fluid level, where the user may grasp the stick and use it to stir the beverage, or alternatively remove the stick from the beverage after the desired steeping time has passed.

The invention is also based, in part on the further insight that although many methods to infuse other agents into cinnamon sticks are possible, in preferred embodiment, the infusion process should operate in a manner that preserves the integrity of the infused agents, while still allowing at least some of the natural cinnamon flavor of the cinnamon stick to elude or leach out from the stick over the comparatively short periods of time (e.g. at most a few minutes) in which the cinnamon stick may be placed in the food or beverage.

Thus if properly added to the cinnamon stick (e.g. infused into the porous cinnamon stick body, and the like), one or more other agents would often tend to rapidly and efficiently diffuse into a beverage, while only trace amounts of the cinnamon flavor will so disperse, thus resulting in a balance of flavors (or other agents) that could be pleasing and/or beneficial to the consumer.

The invention is also based, in part, on the insight that consumers are continually looking for new eating and drinking experiences, and that cinnamon sticks infused with agents such as flavors, vitamins, or food coloring might thus prove compelling to consumers.

The invention is further based, in part, on the insight that cinnamon sticks which have been pre-modified can thus provide added value, such as a richer sensory experience or health benefit during eating or drinking.

### BRIEF DESCRIPTION OF THE DRAWINGS

FIG. 1 shows a diagram of an exemplary process for making flavor-infused cinnamon sticks.

FIG. 2 shows a diagram further illustrating various portions of the FIG. 1 process, here showing a spraying impregnation method in more detail.

FIG. 3 shows a schematic illustrating a vacuum process to impregnate cinnamon sticks with various agents, such as various flavoring agents.

FIG. 4 shows a diagram of other methods to modify cinnamon sticks by the addition of additional agents. Alternative methods could include dipping or enrobing and tumbling or a combination of these or other processes.

### DETAILED DESCRIPTION OF THE INVENTION

In one embodiment, the invention may be an agent infused cinnamon stick. This cinnamon stick will generally be at least semi-rigid, and have a substantially linear structure, a plurality of pores, and at least some water (or food/beverage) soluble cinnamon flavoring compounds. These pores will store, in a dry form, at least one chemical agent (agent), not normally found with cinnamon sticks. The overall structure and composition of the cinnamon stick will be such that when the cinnamon stick is immersed in a hot aqueous fluid (e.g. a hot beverage), the cinnamon stick will retain its substantially linear structure for at least a few minutes while the aqueous fluid (hot beverage) permeates the stick's pores. The fluid will dissolve at least portions of the agent, and liberate it into the surrounding fluid along with usually at least some of the water soluble (or food/beverage soluble) cinnamon flavoring compounds that are normally associated with the cinnamon stick.

In another embodiment, the invention may also be a method of producing chemical agent (agent) infused cinnamon sticks. This method will generally dissolving at least one agent in a carrier fluid, often an alcohol-water mixture, producing an agent solution, and applying this agent solution to usually many cinnamon sticks at the same time. The agent solution will be allowed to permeate the cinnamon sticks, excess agent solution removed as needed, and then the carrier fluid (e.g. the alcohol-water mixture) itself removed (usually by a drying process), thus producing dry cinnamon sticks infused with at least one agent.

Although, to simplify reading, most discussion will relate to flavor-infused cinnamon sticks for hot beverages, and various methods of making the same, the use of “flavor” or “beverage” is not intended to be limiting. In other embodiments, other functional ingredients (agents), such as vitamins, coloring agents, sweetening agents, and the like can also be infused into cinnamon sticks using the methods of the present invention. The sticks in turn can be used to flavor a wide range of hot and cold liquid beverages, semi-solid foods (e.g. yogurt, sauces, etc.) or solid foods as well.

At an abstract level, the invention may be described using the common technical problem, solution to problem format.

### Technical Problem

Currently there is a commercial need (market demand) for natural healthy ingredients for various foods and beverages. Although cinnamon sticks are known to be a useful vehicle for imparting a cinnamon flavor, cinnamon sticks in their current format otherwise are limited in the sense that they are not used for anything beyond this limited purpose.

### Solution to Problem

As previously discussed, the invention is based, in part, on the concept of using cinnamon sticks as a delivery mechanism for other agents.

Here for example, the cinnamon stick as a delivery platform concept can be used to expand this platform to new market sectors by adding other flavors and healthy ingredients like vitamins. This would allow agent infused or modified cinnamon sticks to appeal to a wider cross-section of the population. In addition to consumers interested in novel flavors, the platform could also address various health market segments, such as segments focused on healthy aging, diabetes and cardiovascular disease, proper nutrition, and the like.

To do this, in addition to teaching the concept of agent infused or modified cinnamon sticks as one embodiment of the invention, in another embodiment the invention teaches methods of producing such modified cinnamon sticks that, in a preferred embodiment, allow various agents that impart flavor, color, vitamins or other materials to be incorporated into the cinnamon stick structure in a manner that preserves the inherent length and stiffness of the cinnamon stick, preserves the integrity of the agent, and also allows both the agent and at least traces of cinnamon flavor to elude from the stick over a short (few second to few minutes) period of time.

### Manufacturing Methods

Although many methods to produce the modified cinnamon sticks are possible, based on experimentation, it has been found that vacuum infusion methods have certain advantages.

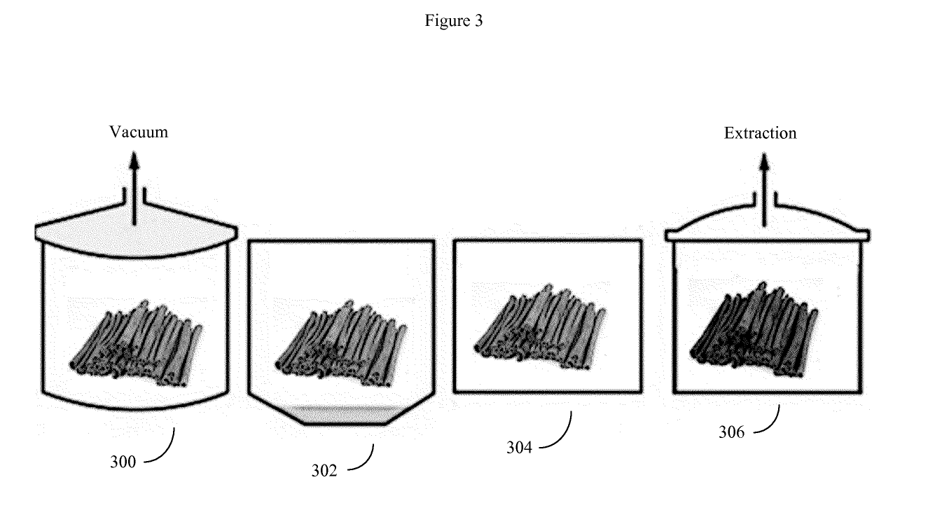

According to the vacuum infusion method (illustrated in FIG. 3), the cinnamon stick quills can be placed in an airtight infusion container in contact with the infusion fluid (containing the dissolved agents), but not completely immersed in the infusion fluid. Air is then removed from the container, and the fluid moves into the various porous voids in the cinnamon stick. This approach has the advantage that the infusion takes place relatively evenly between the various cinnamon sticks, the infusion process proceeds rapidly, and due to the vacuum (or low air pressure, such as less than 20% of normal atmospheric pressure), the infusion fluid travels deeply into the porous cinnamon stick matrix. This helps lock in more of the agent's flavors and aromas, and also helps prevent surface evaporation from hindering flow of the agent into the deeper pores. This method is also good for forcing infusion of some hydrophobic substances (agents), such as oil based extracts, that otherwise would tend not to be absorbed into the hydrophilic cinnamon stick matrix.

According to the vacuum method, and as shown in FIG. 3, in step (300), the cinnamon sticks may be placed in a vacuum chamber, and the air at least partially removed. In step (302), the cinnamon sticks may be exposed to the liquid dissolved agents under low pressure, and the liquid will then flow into the various pores of the cinnamon stick, depositing the agents deep into the cinnamon stick structure as desired. In step (304), the remaining liquid dissolved agents are removed from the chamber. In step (306), the sticks may be dried further under low pressure, and optionally then further treated with heat and/or treated with various stabilizing agents as will be described shortly.

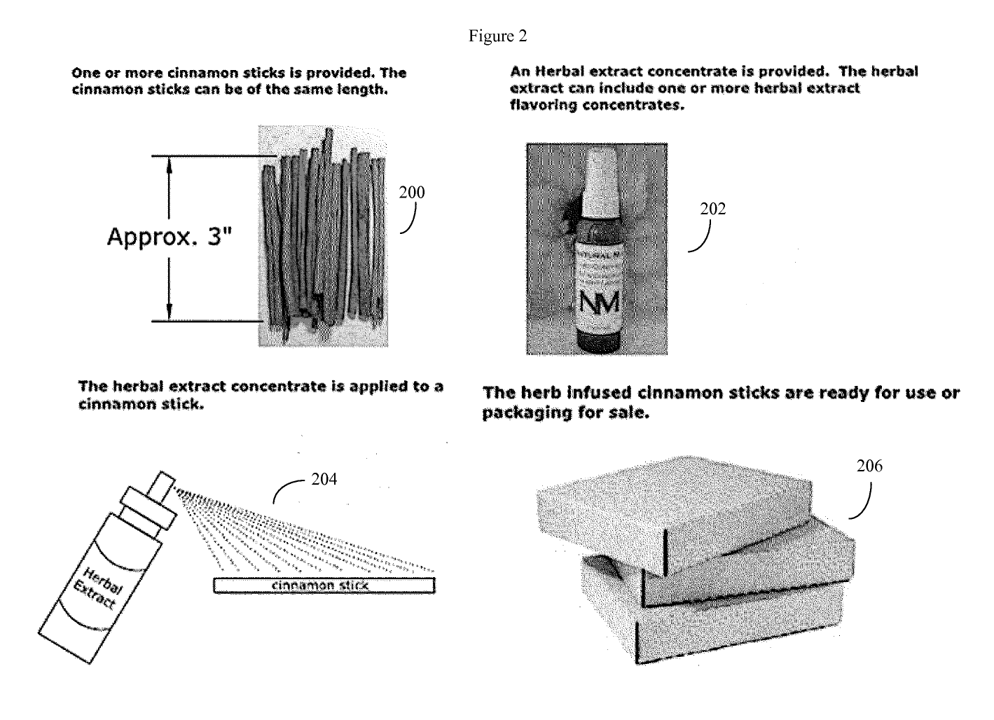

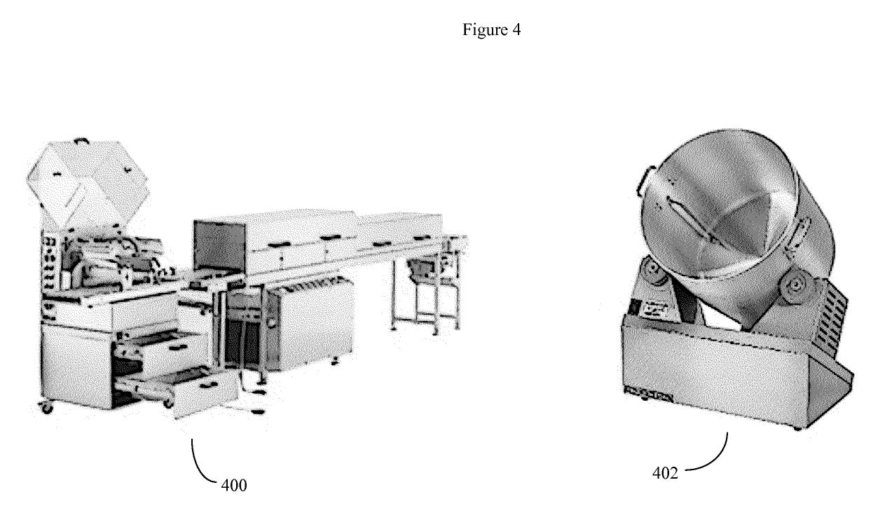

Although vacuum infusion methods are ideal, other infusion methods, such as spray application (illustrated in FIG. 2), or even soaking the cinnamon sticks in the infusion fluid in the absence of a vacuum may also be used. Additionally, methods such as enrobing, spray and tumble methods (illustrated in FIG. 4) and the like may also be used. Indeed essentially any method to saturate the sticks with a fluid containing the agents may be used.

### Preparing the Infusion Solution

Before the cinnamon stick can be infused with the desired chemical agent or agents, the agents should first be dissolved into a carrier fluid. Here use of pure water carrier fluids, although allowable, are not always preferred because over time, water can tend to weaken the structure of the cinnamon stick, and even cause tightly rolled cinnamon sticks, for example, to open up and lose their shape to some extent. As a result, in a preferred embodiment, often the carrier fluid will instead often be based on alcohol-water mixtures.

Thus for example, powdered agents (e.g. powdered flavors, vitamins, sweetening agents (e.g. sucralose) and the like will often be dissolved, preferably at or near the highest possible concentration, in an alcohol-water mix prior to the start of the infusion process. Generally the goal is to use concentrated agents so as to deliver a maximum amount of agent per unit amount of carrier fluid, thus minimizing the damage that the carrier fluid will cause to the cinnamon sticks during the infusion process. In some embodiments, these methods will result in up modified cinnamon sticks that carry as much as 5 to 10% agents by weight (e.g. relative to the weight of the cinnamon stick).

### Stabilizing the Modified Cinnamon Sticks

In some embodiments of the invention, it is also useful, after the initial infusion process, to then perform subsequent operations to help seal the flavors and aromas of the agent into the stick, thus promoting a good shelf life and optionally also facilitating subsequent release of the agent when the stick is subsequently immersed in a food or beverage, such as a hot water based beverage.

Here various sealing methods may be used. For example, in some embodiments, the outside of an infused and dried cinnamon stick quill may be sprayed with an aerosol-like glycerin mix, and then dried again. This results in a thin layer of glycerin surrounding the cinnamon stick, and helps promote a longer (e.g. year or more) shelf life for the final product. For an 8 gram cinnamon stick, often 0.2 to 0.4 grams of glycerin may be applied using this method. Other stabilizing agents may also be used.

### Types of Agents

Types of flavorings: in addition to various herbal flavorings, many other types of flavorings may also be imbedded or infused into the cinnamon stick according to the invention. Some of these other flavorings include vanilla, mint or peppermint, apple, orange, pumpkin, butter, or various natural or artificial sweeteners.

Many of the agents may be chosen so as to be suitable for herbal tea-like beverage. Herbal tea is often a relatively simple combination of boiling water and dried teas, fruits, flowers, herbs and/or the like. One of the main ingredients of many herbal tea varieties is cinnamon. For example, cinnamon (or cinnamon flavoring) can be used in varieties of herbal beverages such as: apple cider, Indian chai, citrus blend beverages and the like. However, in conventional teas, the cinnamon may be a separate ingredient in a teabag, pouch or filter. According to the invention, however, the soluble herbal tea substances may instead be concentrated and applied to the cinnamon stick. The net result can be a modified cinnamon stick that either produces a flavored herbal tea-like beverage when immersed in hot water by itself, or a modified cinnamon stick that can be used to supplement the flavor of a first herbal tea with a second set of flavors intended to complement the flavor of the first herbal tea.

Depending on the market in question, the agents may be deposited on the outside of the cinnamon stick, and/or in the central core of the cinnamon stick. As previously discussed, impregnation and drying can often be facilitated by use of vacuum methods. The main goal of the process is to produce a robust product that can be easily packaged into wrapped single cinnamon stick units (e.g. for hotel/restaurant use) or which can be easily packaged into multiple units (e.g. retailers, home use). The final product can thus be used and sold in a wide range of food and beverage applications such as for use in sweet or savory foods or beverages, alcoholic and non-alcoholic beverages, dairy foods and beverages, confectionary foods, and the like.

Figures showing the manufacturing methods in operation:

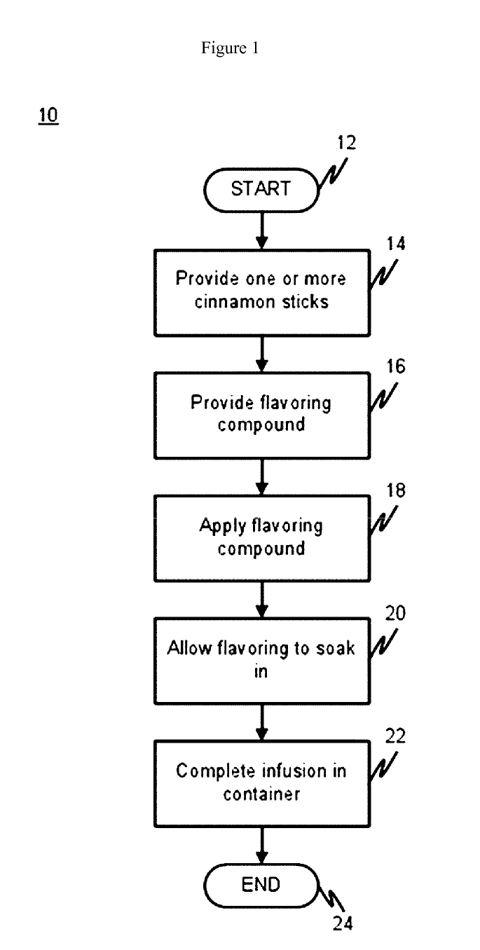

FIG. 1 shows a process (10) for making flavor-infused cinnamon sticks. The process (10) begins at (12) and continues to (14).

At step (14), one or more cinnamon sticks are provided. The cinnamon sticks can be of the same length, e.g., about 3 inches long. The process continues to (16).

At step (16), a flavoring compound (e.g., an herbal extract concentrate) is provided. The herbal extract can include one or more herbal extract flavoring (or aroma) concentrates. In addition to herbs, the extracts can include extracts of other plants, fruits, vegetables or the like. The flavoring compound can be natural flavoring or aroma compounds or artificial flavoring or aroma compounds, or a combination of the above. The process continues to (18).

At step (18), the flavoring compound is applied to a cinnamon stick. The flavoring compound can be applied to the inside or outside (or both) of the cinnamon stick. A predetermined amount of flavoring can be used per stick. For example, an average cinnamon stick may weigh about 5 grams and the flavoring compound can comprise about 3-6% of the finished product by weight. The process continues to (20).

At step (20), the flavoring compound is allowed to optionally soak into the cinnamon stick for a predetermined period of time. The process continues to (22).

At step (22), the cinnamon sticks with flavoring compounds applied are placed into a container with sticks of the same flavor, the container can be sealed and the infusion process can be allowed to continue during a second predetermined period of time (e.g., about 24 hours or more). The process continues to (24).

At step (24), the flavor-infused cinnamon sticks are ready for use or packing for sale.

FIG. 2 shows this process in more detail. Here step (14) is shown in more detail as (200). As previously discussed for step (14), the unmodified cinnamon sticks are provided, preferably all approximately 3 inches long and all approximately the same length.

Step (16) is shown in more detail in (202). Here the flavoring compound, such as the herbal extract concentrate, is provided as previously described.

Steps (18) and (20) are shown in more detail in (204). Here the flavoring compound (here an herbal extract concentrate) is applied to the cinnamon sticks as previously described. A number of different methods may be used to apply this flavoring compound, as described elsewhere.

Step (24) is shown in more detail in (206). Here the flavor infused cinnamon sticks are shown packed and ready for resale and use.

As previously discussed, although vacuum infusion methods are particularly useful, many other methods may also be used to produce the modified cinnamon sticks. Some of these methods include dipping, enrobing, vacuum tumbling or spraying, electrostatic spraying etc. Examples of the equipment used for the enrobing and spray and tumbling methods are shown in FIG. 4.

FIG. 4 shows an example of enrobing equipment (400), which may be used in a manner similar to those used by chocolate filled bar manufacturers), and spray and tumble equipment (402).

### EXAMPLES

### Example 1

An embodiment includes an infused cinnamon stick with flavor. The infused flavors can be single flavors or combinations of flavors. For example, to infuse cinnamon sticks with flavors from each recipe, varied amounts of natural herbal extracts of the respective flavors, or very similar ones can be used to infuse the cinnamon sticks for each respective flavoring recipe. Another embodiment would be a Cinnamon Stick infused with a functional ingredient such as a vitamin.

Infusion of herbal flavors can be accomplished using oil or alcohol based herb (or other flavoring) extracts. The infusion flavorings can be natural or artificial flavorings.

Natural herbal extracts are typically a preparation in which the active flavor or aromatic compounds of an herb are extracted into alcohol (or oil). This process concentrates and preserves the qualities of the herb flavor. Extracts are sold commercially, and used specifically to create soft drinks and beverages, for example.

An embodiment can include a process to manufacture a flavor-infused cinnamon stick. For example, the process can include providing a cinnamon stick and applying a predetermined amount of concentrated extract flavoring (one or two drops) on the inside (the lumen) and/or outside of a cinnamon stick (a cinnamon stick typically 3 inches in length but other sizes can be used depending on the market application), and is left for a predetermined time period (typically a few seconds) to absorb into the woody part of the cinnamon stick. The stick is then left for another predetermined time period (e.g., about 24 hours or less if vacuum applied) to facilitate the infusion process in a closed container with other sticks of the same flavor recipe. The flavor or flavors can be further fixed into place using edible adhesives based on carbohydrates and gums.

A typical process would be thus:

Take 2 g of natural flavor (in 0.4 g of alcohol) and add to 8 g of Cinnamon sticks. Leave for 12 hours.

The process conditions would change and are dependent on the type of adduct or flavor to be infused into the cinnamon stick and the degree to which the desired effect is required.

### Example 2

A similar process could be used to incorporate functional health ingredient such as vitamins, antioxidants, natural edible colors, sweeteners, or bioactive ingredients etc.

Other treatments can also include fixing the agent or adduct in the cinnamon stick either chemically or with heat. This will protect the product and aid release only when the Cinnamon stick is in use.

### Example 3

Another embodiment can include a process to add edible dyes, inclusions and other ingredients to the cinnamon stick. For example: vitamins or ingredients that relieve upset stomach and agents that can boost energy.

In use, the adduct-infused cinnamon stick can be placed in boiling or hot water so that the cinnamon releases the flavor of the cinnamon along with the flavors of the infused flavors (e.g. herbal extracts) to create a flavor and aroma of a particular recipe. The flavor and aroma will depend on the extracts used in the recipe. The cinnamon stick is typically not eaten, only placed into a drink or food dish to impart flavors and/or aromas. However, because of its versatile flavoring, a flavor-infused cinnamon stick can be used for hot or cold drinks, and also for sweet or savory foods, such as soups, rice, beef casseroles, or the like. For the functional health ingredients a similar process is recommended where the cinnamon stick infused with ingredient is placed in hot or boiling water. It can also be envisioned that this invention can be used in cold drinks for example alcoholic and non-alcoholic cocktails.

### Supporting Data

During the development of prototypes, 120 infusion drinkers were given samples to taste in a simple test. Three samples were rated for naturalness, flavor and aroma. The three samples were as follows: (i) a Cinnamon flavor Infused Stick (ii) a control commercial loose tea infusion from company A and (iii) a control commercial loose tea infusion from company B. The Cinnamon infused stick was matched as closely as possible in previous trials to match the commercial samples. The modified cinnamon stick was rated first for naturalness, flavor and aroma. The experiment was conducted under controlled conditions for example tea bags and cinnamon sticks were removed from the samples prior to presenting to the panels to avoid any visual bias.

It is, therefore, apparent that there is provided, in accordance with the various embodiments disclosed herein, flavor-infused cinnamon sticks and a method of making the same.

While the invention has been described in conjunction with a number of embodiments, it is evident that many alternatives, modifications and variations would be or are apparent to those of ordinary skill in the applicable arts. Accordingly, the applicant intends to embrace all such alternatives, modifications, equivalents and variations that are within the spirit and scope of the invention.

1. A method of producing an agent infused cinnamon stick, said method comprising:
dissolving at least one agent in a carrier fluid, producing an agent solution;
applying said agent solution to a plurality of cinnamon sticks;
allowing said agent solution to permeate said cinnamon sticks;
removing said carrier fluid, thereby producing dry cinnamon sticks infused with said at least one agent.

2. The method of claim 1, wherein said carrier fluid is an alcohol-water solution chosen to both solubilize said agents, and also to preserve the structure of said cinnamon sticks while said agent solution is permeating said cinnamon sticks.

3. The method of claim 1, wherein said agent comprises one or more agents selected from the group consisting of flavoring compounds, vitamins, food colorants, and sweeteners.

4. The method of claim 1, wherein said cinnamon sticks are exposed to low air pressure or a vacuum either during or immediately prior to exposure to said agent solution.

5. The method of claim 1, wherein said agent solution is applied to said plurality of cinnamon sticks using one or more methods selected from the group consisting of infusion, spraying, tumbling and enrobing methods.

6. The method of claim 1, wherein said carrier fluid is removed by drying at normal or elevated heat under either normal air pressure, low air pressure, or in a vacuum.

7. The method of claim 1, wherein after drying, said at least one agent comprises 1 to 15% of the weight of the cinnamon stick.

8. The method of claim 1, wherein after drying, said at least one agent comprises 3 to 5% of the weight of the cinnamon stick.

9. The method of claim 1, wherein said cinnamon sticks have a length between 2 and 5 inches long.

10. The method of claim 1, wherein after said dry cinnamon sticks are produced, said dried cinnamon sticks are subsequently treated with a stabilizing material.

11. The method of claim 10, wherein said stabilizing material comprises glycerin.

12. The method of claim 10, wherein said after treatment with said stabilizing material, said cinnamon sticks are again dried and subsequently packaged.

13. An agent infused cinnamon stick with a substantially linear structure and at least some water soluble cinnamon flavoring compounds, comprising:
a cinnamon stick, said cinnamon stick having a plurality of pores;
said plurality of pores storing at least one agent in dry form;
wherein when said cinnamon stick is immersed in a hot aqueous fluid, said cinnamon stick retains its substantially linear structure while said aqueous fluid permeates said pores, and dissolves said at least one agent, thus liberating dissolved said agent along with at least some said water soluble cinnamon flavoring compounds into said hot aqueous fluid.

14. The agent infused cinnamon stick of claim 13, wherein said agent comprises one or more agents selected from the group consisting of flavoring compounds, vitamins, food colorants, and sweeteners.

15. The agent infused cinnamon stick of claim 13, wherein after drying, said at least one agent comprises 1 to 15% of the weight of the cinnamon stick.

16. The agent infused cinnamon stick of claim 13, wherein after drying, said at least one agent comprises 3 to 5% of the weight of the cinnamon stick.

17. The agent infused cinnamon stick of claim 13, wherein said cinnamon sticks have a length between 2 and 5 inches long.

18. The agent infused cinnamon stick of claim 13, wherein said cinnamon sticks further comprise at least a surface layer of a stabilizing material chosen to improve the shelf life of said agent infused cinnamon sticks.

19. The agent infused cinnamon stick of claim 18, wherein said stabilizing material comprises glycerin.
